(19) United States
(12) Patent Application Publication
(10) Pub. No.: US 2024/0149090 A1
(43) Pub. Date: May 9, 2024

(54) FIRE EXTINGUISHER VALVE FOR A FIRE EXTINGUISHING SYSTEM, FIRE EXTINGUISHING SYSTEM COMPRISING SUCH FIRE EXTINGUISHER VALVE, AND METHOD OF OPERATING A FIRE EXTINGUISHER VALVE

(71) Applicant: KIDDE-DEUGRA Brandschutzsysteme GmbH, Ratingen (DE)

(72) Inventors: Ralf Dreisilker, Velbert (DE); Erdinc Kacar, Krefeld (DE)

(73) Assignee: KIDDE-DEUGRA Brandschutzsysteme GmbH, Ratingen (DE)

(21) Appl. No.: 18/502,906

(22) Filed: Nov. 6, 2023

(30) Foreign Application Priority Data
Nov. 7, 2022 (EP) 22205941.2

(51) Int. Cl. A62C 37/46

(52) U.S. Cl. CPC A62C 37/46

(57) ABSTRACT

A fire extinguisher valve for controlling a flow of a fire extinguishing agent in a fire extinguishing system comprises a valve body; a manual lever, which is manually movable between an open position, in which a fire extinguishing agent discharge path through the valve body is established, and a closed position, in which the fire extinguishing agent discharge path through the valve body is closed; and a mechanical actuator, which is mounted to and supported by the valve body. The mechanical actuator comprises an actuation element for acting upon the manual lever for moving the manual lever from its closed position to its open position; an elastic element for moving the actuation element, and a trigger mechanism for holding the actuation element in a preloaded position, in which the elastic element is preloaded, and for releasing the actuation element, when the mechanical actuator is activated.

### CROSS-REFERENCE TO RELATED APPLICATIONS

This application claims priority to and the benefit of European Patent Application No. EP22205941.2, filed Nov. 7, 2022, the entire content of which is incorporated herein by reference.

### TECHNICAL FIELD

The present invention is in the field of fire extinguishing systems. In particular, the present invention is in the field of fire extinguisher valves for fire extinguishing system. The present invention is further in the field of vehicles and buildings comprising fire extinguishing systems. The present invention also includes a method of operating a fire extinguisher valve, and a method of retrofitting a fire extinguisher valve.

### BACKGROUND

There are fire extinguishing systems which are manually operated by a human. Such fire extinguishing systems may comprise a manual operation element, which is to be moved by the human operator for opening a fire extinguisher valve for activating the fire extinguishing system. The activation of a manually operated fire extinguishing system may be unreliable, as it depends on the presence and proper action of a human operator for detecting a fire and activating the fire extinguishing system.

It would therefore be beneficial to provide fire extinguishing systems and components thereof that allow for an enhanced activation of the fire extinguishing systems.

### SUMMARY

Exemplary embodiments of the invention include a fire extinguisher valve for controlling a flow of a fire extinguishing agent in a fire extinguishing system, the fire extinguisher valve comprising: a valve body; a manual lever, which is manually movable between an open position, in which a fire extinguishing agent discharge path through the valve body is established, and a closed position, in which the fire extinguishing agent discharge path through the valve body is closed. The fire extinguisher valve further comprises a mechanical actuator, which is mounted to and supported by the valve body. The mechanical actuator comprises: a mechanical actuation element for acting upon the manual lever, in order to move the manual lever from its closed position to its open position; an elastic element for driving the actuation element; and a trigger mechanism for holding the actuation element in a preloaded position, in which the elastic element is preloaded, when the mechanical actuator is not activated, and for releasing the actuation element, when the mechanical actuator is activated.

Exemplary embodiments of the invention also include a fire extinguishing system comprising a reservoir for accommodating a fire extinguishing agent and a fire extinguisher valve according to an exemplary embodiment of the invention. The fire extinguisher valve may be fluidly coupled to the reservoir for controlling a flow of the fire extinguishing agent out of the reservoir.

Exemplary embodiments of the invention further comprise a method of operating a fire extinguisher valve according to an exemplary embodiment of the invention, wherein the method includes activating the mechanical actuator, releasing the actuation element in response to activating the mechanical actuator, and moving the manual lever with the actuation element from its closed position into its open position.

A fire extinguisher valve comprising a mechanical actuator according to an exemplary embodiment of the invention allows for mechanically opening a manual fire extinguisher valve, i.e. a fire extinguisher valve that was originally designed for being operated manually by a human. This allows for opening the fire extinguisher valve remotely and/or in an automated manner without human intervention.

The mechanical actuator is mounted to and supported by the valve body. In this way, the mechanical actuator may have stable support, allowing the mechanical actuator to apply the force required moving the manual lever. Also, with the mechanical actuator being mounted to and supported by the valve body, the mechanical actuator may be independent from the remainder of the fire extinguishing system, in particular independent from the mechanical set-up of the remainder of the fire extinguishing system. The mechanical actuator functionality may be implemented solely in cooperation with the valve body and the manual lever of the fire extinguisher valve and may not require any interaction/engagement with other components of the fire extinguisher system.

In an embodiment, the mechanical actuator is a separate component, i.e. a component which is not formed integrally with the valve body. Instead, the mechanical actuator may be mountable and individually separable from the valve body. This may allow for retrofitting an existing manual fire extinguisher valve with a mechanical actuator according to an exemplary embodiment of the invention, in order to allow for a mechanical activation of the fire extinguisher valve. This in turn may allow for retrofitting an existing fire extinguishing system by upgrading/adapting the fire extinguisher valve only.

Exemplary embodiments of the invention may therefore include a method of retrofitting a fire extinguisher valve for controlling a flow of a fire extinguishing agent in a fire extinguishing system, the fire extinguisher valve comprising a valve body and a manual lever, which is manually movable between an open position, in which a fire extinguishing discharge path through the valve body is established, and a closed position, in which the fire extinguishing discharge path through the valve body is closed, wherein the method includes mounting a mechanical actuator to the valve body of the fire extinguisher valve, wherein the mechanical actuator comprises an elastic element, which acts upon a mechanical actuation element for moving the manual lever from its closed position to its open position, and a trigger mechanism for holding the actuation element in a preloaded position and for releasing the actuation element, when the mechanical actuator is activated.

In an embodiment, the elastic element comprises a spring. The spring may be a compression spring. In particular, the spring may be a helical spring or a plate spring or another suitable type of spring. The spring may in particular be made of metal. A spring, such as a helical spring or a plate spring, may be selected/designed to provide a force that is sufficiently large for moving the manual lever, and the expansion of the spring may be large enough for reliably moving the manual lever from its closed position to its open position.

In an embodiment, the elastic element is configured for causing the actuation element to exert a force in a range of between 50 N and 250 N, in particular a force in a range of between 90 N and 150 N, onto the manual lever for reliably moving the manual lever from its closed position to its open position.

The elastic element may be configured for moving the actuation element over a distance in the range of between 5 mm and 40 mm, in order to reliably move the manual lever from its closed position to its open position. In other words, the actuation element may travel a distance of between 5 mm and 40 mm, when set in motion by the elastic element. The travel distance of the actuation element may be limited by a stop surface. It is possible that the manual lever, once put in motion by the actuation element, travels a larger distance.

In an embodiment, the trigger mechanism comprises a movable latch, which is movable between a locking position and a released position. When arranged in the locking position, the movable latch may lock the actuation element in a preloaded position, in which the elastic element is compressed. When arranged in the released position, the movable latch may allow the elastic element to expand and to move the actuation element from its preloaded position into a released position. A movable latch may allow for providing a reliable locking mechanism, which is able to securely lock the actuation element, when the mechanical actuator is not activated, and which is able to reliably release the actuation element for moving the manual lever into its open position, when the mechanical actuator is activated.

In an embodiment, the trigger mechanism is an electromagnetic trigger mechanism. The trigger mechanism may in particular comprise a solenoid for releasing a blocking mechanism to allow the movable latch to move into the released position, when an electric current flows though the solenoid. Such a configuration may allow for activating the mechanical actuation electrically by causing an electric current to flow through the solenoid. Activating the mechanical actuator electrically may allow for activating the mechanical actuator in an automated manner and/or remotely.

In an embodiment, the fire extinguishing agent, which may be provided in the reservoir of a fire extinguishing system according to an exemplary embodiment of the invention, may include at least one of a fire extinguishing gas, such as CO₂, a liquefied fire extinguishing gas, for example liquefied FE36, a fire extinguishing liquid, such as water, a dry chemical fire extinguishing agent, in particular a dry chemical fire extinguishing agent provided in powder form, and/or a liquid foam, e.g. DEUFOAM-Plus®. The fire extinguishing agent may further include a propellant, such as nitrogen, for driving the liquid and/or the dry chemical agent out of the reservoir, when the fire extinguisher valve is open.

In an embodiment, the fire extinguishing system comprises a controller for activating the mechanical actuator, when a fire has been detected and/or when a fire alarm signal has been received. Such a controller may allow for activating the fire extinguishing system in an automated manner and/or remotely. As a result, the reliability of the fire extinguishing system may be increased and the fire safety of the environment around the fire extinguishing system may be enhanced.

In an embodiment, the fire extinguishing system further comprises at least one fire sensor for detecting a fire. This may allow for automatically activating the mechanical actuator for opening the fire extinguisher valve when a fire has been detected by one or more of the at least one fire sensor. The at least one fire sensor may include a temperature sensor, a smoke detector, a carbon monoxide detector, an optical detector, such as an IR sensor, a combination of any two or all of a temperature sensor, a smoke detector, a carbon monoxide detector, and an optical detector, or any other suitable fire sensor.

In an embodiment, the fire extinguishing system, in particular the controller, comprises at least one fire alarm signal input for receiving a fire alarm signal. This may allow for activating the mechanical actuator for opening the fire extinguisher valve by supplying a fire alarm signal to the fire extinguishing system. The fire alarm signal may, for example, be supplied by an external fire sensor. The fire alarm signal may also be supplied by a manually triggered fire alarm switch, which is triggered by a human upon noticing a fire.

In an embodiment, the fire extinguishing system is a portable fire extinguishing system. The portable fire extinguishing system may include a container or bottle, which provides a reservoir for accommodating the fire extinguishing agent, and a fire extinguisher valve according to an exemplary embodiment of the invention, which is mounted to the container or bottle. The fire extinguishing system may in particular be a handheld fire extinguishing system.

In an embodiment, the fire extinguishing system is a stationary fire extinguishing system, in particular a fire extinguishing system that is configured to be installed in a building or in a vehicle. In this context, a fire extinguishing system, which is permanently installed in a vehicle, is considered to be a stationary fire extinguishing system, as it is stationary with respect to the vehicle, although the vehicle itself is movable.

Exemplary embodiments of the invention further include a vehicle which is equipped with a fire extinguishing system according to an exemplary embodiment of the invention. Installing a fire extinguishing system according to an exemplary embodiment of the invention in a vehicle may enhance the safety of the vehicle, as fires in the vehicle may be fought fast and efficiently, and optionally in an automated manner, by activating the mechanical actuator for opening the fire extinguisher valve of the fire extinguishing system.

In an embodiment, the vehicle is a land vehicle, in particular a wheeled land vehicle, for example a car, a truck or a bus. The vehicle may also be a military vehicle, in particular an armored military vehicle.

In an embodiment, the vehicle comprises an engine located in an engine compartment, and the fire extinguishing system is at least partially located within the engine compartment for efficiently fighting a fire break out at the engine or in the engine-compartment.

In an embodiment, the vehicle comprises a passenger cabin and the fire extinguishing system is at least partially located within the passenger cabin for efficiently fighting fires in the passenger cabin. This may enhance the safety of the passengers.

In an embodiment, the vehicle comprises a baggage compartment and the fire extinguishing system is at least partially located within the baggage compartment for efficiently fighting fires in the baggage compartment. This may enhance the safety of the vehicle even further.

In an embodiment, multiple fire extinguishing systems according to exemplary embodiments of the invention are installed in the vehicle. In particular, separate fire extinguishing systems may be provided for the engine compartment and/or the passenger cabin and/or the baggage compartment.

### BRIEF DESCRIPTION OF THE DRAWINGS

So that those skilled in the art to which the subject disclosure appertains will readily understand how to make and use the devices and methods of the subject disclosure without undue experimentation, other embodiments thereof will be described in detail herein below with reference to certain figures, wherein:

FIG. 1A shows a side view of a fire extinguisher valve according to an exemplary embodiment of the invention in a closed state.

FIG. 1B shows a partial cross-sectional view of the fire extinguisher valve shown in FIG. 1A.

FIG. 10 shows a perspective view of the fire extinguisher valve shown in FIGS. 1A and 1B.

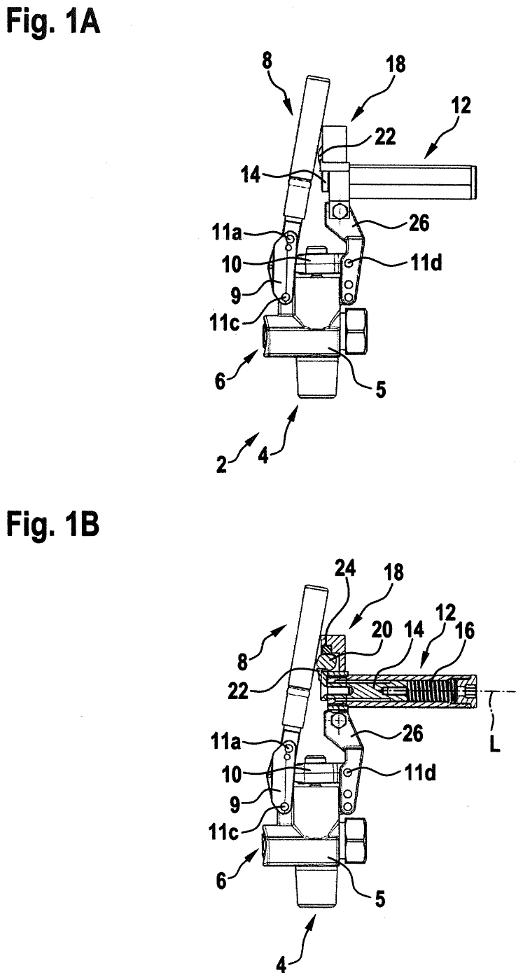

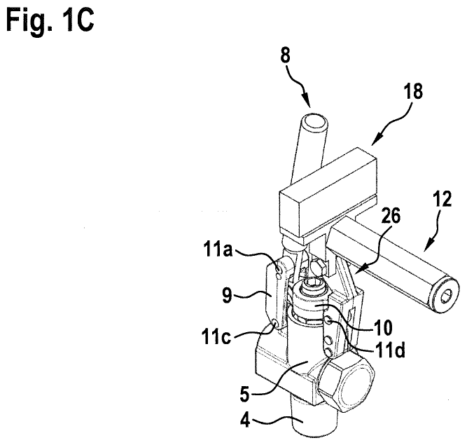

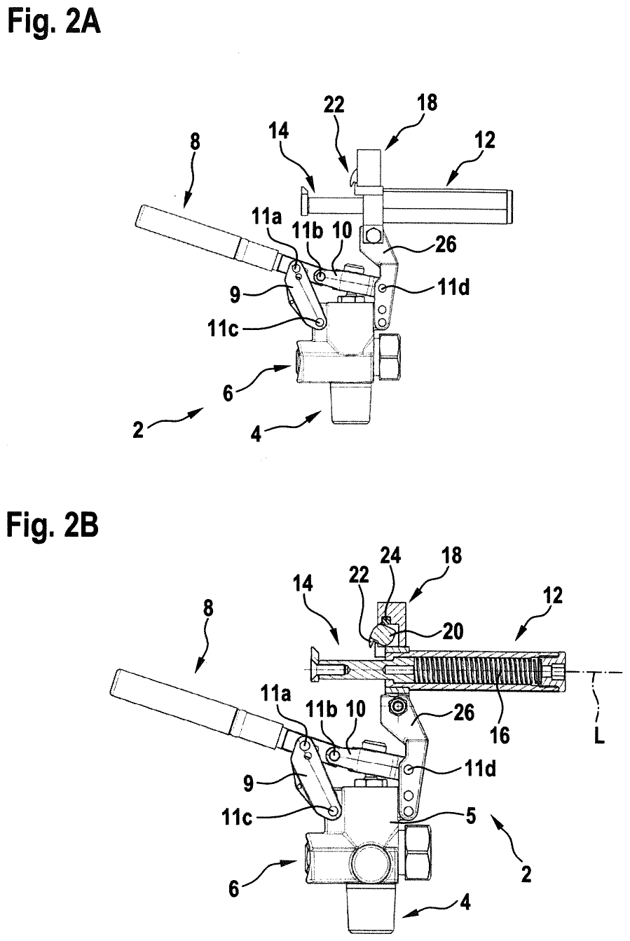

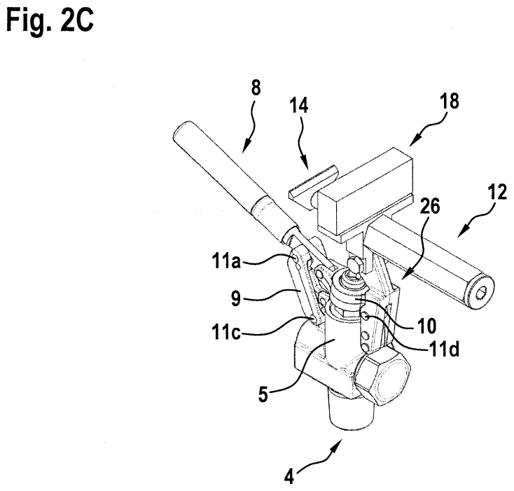

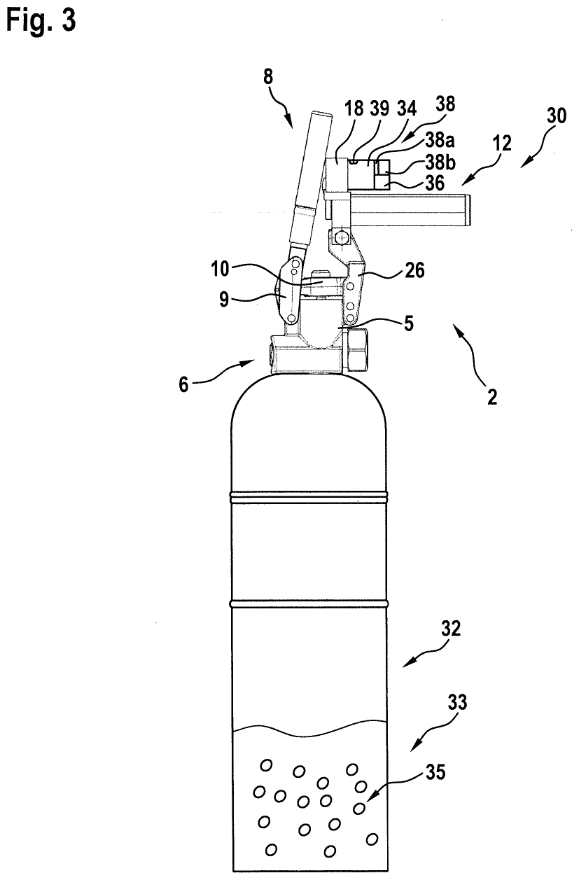

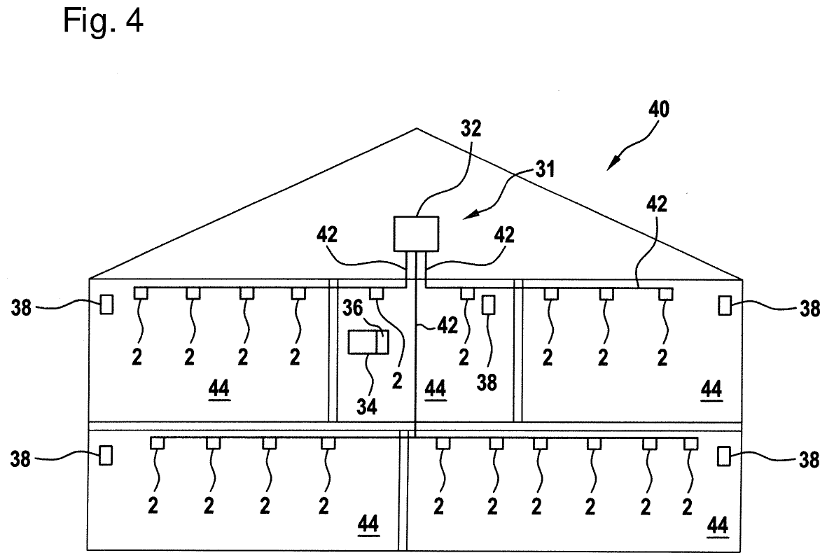

FIG. 2A shows a side view of the fire extinguisher valve shown in FIGS. 1A to 10 in an open state.

FIG. 2B shows a partial cross-sectional view of the fire extinguisher valve shown in FIG. 2A.

FIG. 2C shows a perspective view of the fire extinguisher valve shown in FIGS. 2A and 2B.

FIG. 3 shows an exemplary embodiment of a portable handheld fire extinguishing system according to an exemplary embodiment of the invention, comprising a fire extinguisher valve according to an exemplary embodiment of the invention.

FIG. 4 shows an exemplary embodiment of a building that is equipped with a stationary fire extinguishing system according to an exemplary embodiment of the invention, comprising fire extinguisher valves according to exemplary embodiments of the invention.

FIG. 5 shows an exemplary embodiment of a vehicle that is equipped with a fire extinguishing system according to an exemplary embodiment of the invention, comprising a fire extinguisher valve according to an exemplary embodiment of the invention.

FIG. 6 shows an exemplary embodiment of another vehicle that is equipped with a fire extinguishing system according to exemplary embodiment of the invention, comprising a fire extinguisher valve according to an exemplary embodiment of the invention.

### DETAILED DESCRIPTION

In the following, an exemplary embodiment of a fire extinguisher valve and exemplary embodiments of several fire extinguishing systems according to exemplary embodiments of the invention are described in more detail with reference to the enclosed drawings.

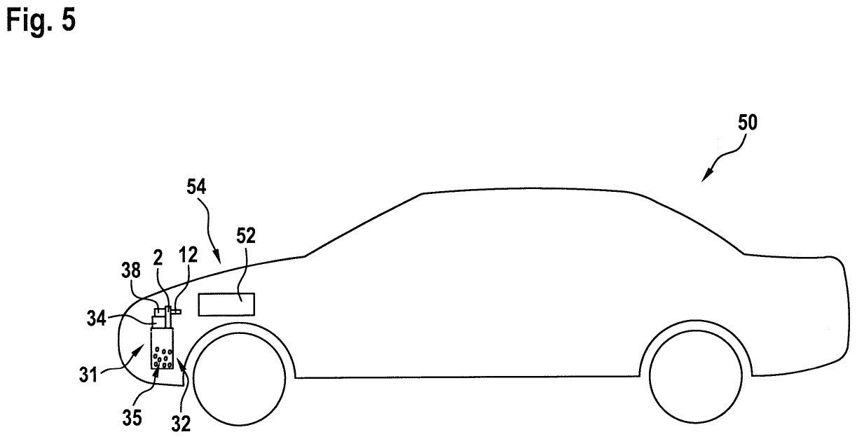

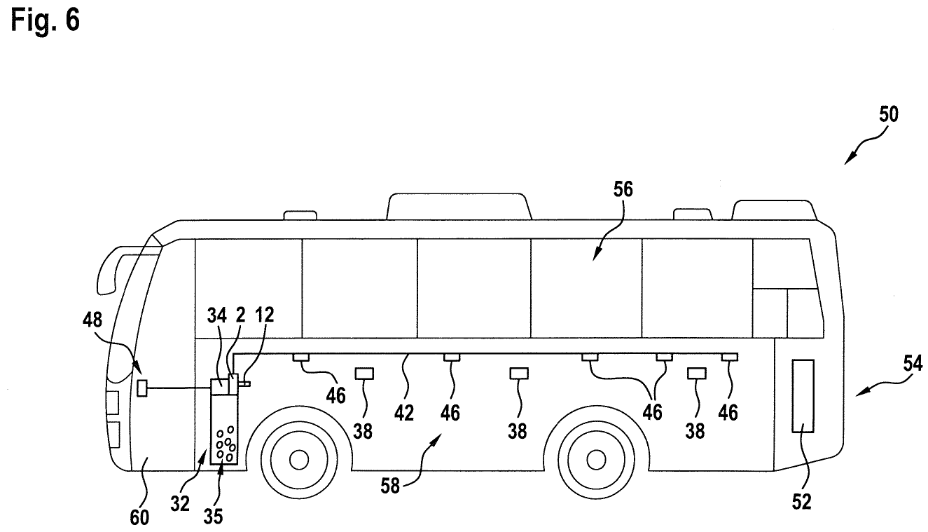

FIGS. 1A to 10 show a fire extinguisher valve 2 according to an exemplary embodiment of the invention in a closed state. FIG. 1A shows a side view of the fire extinguisher valve 2, FIG. 1B shows a partial cross-sectional view of the fire extinguisher valve 2, and FIG. 10 shows a perspective view of the fire extinguisher valve 2.

FIGS. 2A to 2C show the fire extinguisher valve 2, which is shown in FIGS. 1A to 10, in an open state. FIG. 2A shows a side view of the fire extinguisher valve 2, FIG. 2B shows a partial cross-sectional view of the fire extinguisher valve 2, and FIG. 2C shows a perspective view of the fire extinguisher valve 2.

The fire extinguisher valve 2 comprises a valve body 5 and an input connector 4, which is fluidly connected to the valve body 5. The input connector 4 is connectable to a fire extinguishing agent reservoir, which is not shown in FIGS. 1A to 2C. Examples of fire extinguishing agent reservoirs 32 are shown in FIGS. 3 to 6. The reservoir 32 is configured for storing a fire extinguishing agent 35 (see FIG. 3). The valve body 5 further comprises an output 6 for dispensing the fire extinguishing agent 35 from the reservoir 32.

When the fire extinguisher valve 2 is in an open state, as it is depicted in FIGS. 2A to 2C, the reservoir is fluidly connected to the output 6 via a fire extinguishing agent discharge path, which is formed within the valve body 5. In this way, the fire extinguishing agent 35 may be enabled to flow from the reservoir 32 through fire extinguishing agent discharge path to the output 6 of the fire extinguisher valve 2 for being dispensed. A fire extinguisher nozzle (not shown) may be provided at the output 6 for dispensing the fire extinguishing agent 35.

When the fire extinguisher valve 2 is in a closed state, as it is depicted in FIGS. 1A to 10, the fire extinguishing agent discharge path within the valve body 5 is blocked, so that no fire extinguishing agent 35 is delivered from the reservoir 32 to the output 6.

The fire extinguisher valve 2 further comprises a manual lever 8, which is manually movable between a closed position, as depicted in FIGS. 1A to 10, and an open position, which is depicted in FIGS. 2A to 2C. When the manual lever 8 is in the closed position, the fire extinguishing agent discharge path through the valve body 5 is blocked. When the manual lever 8 is in the open position, the fire extinguishing agent discharge path through the valve body 5 is open, allowing the fire extinguishing agent 35 to flow from the reservoir 32 through the fire extinguishing agent discharge path to the output 6.

The manual lever 8 is pivotably connected to a support lever 9 by a first bearing 11a and to an actuation lever 10 by a second bearing 11b. The support lever 9 and the actuation lever 10 are both pivotably connected to the valve body 5 by a third bearing 11c and a fourth bearing 11d, respectively. The support lever 9 and the actuation lever 10 may be moved by pivoting the manual lever 8 between its closed position and its open position.

When the manual lever 8 is moved from its closed position, as depicted in FIGS. 1A to 10, into its open position, as depicted in FIGS. 2A to 2C, the actuation lever 10 is pivotably lifted from the valve body 5. This movement of the actuation lever 10 opens the fire extinguishing agent discharge path, which extends through the valve body 5.

The fire extinguisher valve 2 further comprises a mechanical actuator 12. The mechanical actuator 12 is mounted to and supported by a support 26, which is mounted to the valve body 5. The mechanical actuator 12 is configured for acting upon the manual lever 8 for selectively moving the manual lever 8 from its closed position into its open position.

The mechanical actuator 12 comprises a movable actuation element 14, in particular a piston 14, for acting upon the manual lever 8, in order to move the manual lever 8 from its closed position to its open position. The mechanical actuator 12 further comprises an elastic element 16 for moving the actuation element 14 by expanding the elastic element 16.

In the embodiment depicted in FIGS. 1A to 2C, the elastic element 16 is a helical spring 16, extending along a longitudinal direction L. As shown in FIG. 1B, the helical spring 16 is compressed along the longitudinal direction L, when the mechanical actuator 12 is in a preloaded state, i.e. in a state in which it is not activated. The helical spring 16 may also be described as being in a preloaded state.

The elastic element 16 may be configured for causing the actuation element 14 to exert a force in a range of between 50 N and 250 N, in particular a force in a range of between 90 N and 150 N, onto the manual lever 8, in order to reliably move the manual lever 8 from its closed position into its open position for opening the fire extinguisher valve 2.

The elastic element 16 may further be configured for moving/pushing the actuation element 14 over a distance in the range of between 5 mm and 40 mm, in order to reliably move/push the manual lever 8 from its closed position into its open position.

The mechanical actuator 12 also comprises a trigger mechanism 18. The trigger mechanism 18 holds the actuation element 14 in the preloaded position, when the mechanical actuator 12 is in the preloaded, not activated state. The trigger mechanism 18 may in particular prevent the elastic element 16 from expanding from its compressed preloaded state, which is shown in FIG. 1B, into the released state, which is shown in FIG. 2B.

The trigger mechanism 18 may comprise a movable latch 20, which is movable between a locking position and a released position.

When in the locking position (see FIG. 1B), a protrusion 22, which extends from the latch 20, holds the actuation element 14 in the preloaded position, in which the elastic element 16 is compressed.

In the released position (see FIG. 2B), the latch 20 is pivoted into an orientation, in which the protrusion 22 does not block the actuation element 14. Instead, the elastic element 16 is allowed to expand and to move the actuation element 14 from its preloaded position into the released position.

When being moved from the preloaded position into the released position, the actuation element 14 engages the manual lever 8 and moves the manual lever 8 from its closed position to its open position, thereby opening the fire extinguisher valve 2.

The trigger mechanism 18 may be an electromagnetic trigger mechanism including a solenoid 24. When being activated by flowing an electric current through the solenoid 24, the solenoid 24 releases a locking-mechanism and allows the latch 20 to move from its locking position into its released position.

The mechanical actuator 12 is a separate component. I.e. the mechanical actuator 12 is not formed integrally with the valve body 5. Instead, the mechanical actuator 12 is supported by the support 26, which is mounted to the valve body 5. Providing the mechanical actuator 12 as a separate component, which is not formed integrally with the valve body 5, may allow for selectively mounting the mechanical actuator 12 to the valve body 5 and for individually separating the mechanical actuator 12 from the valve body 5, when desired.

A support 26 and a mechanical actuator 12 according to exemplary embodiments of the invention may in particular be added to an existing conventional, manually operated fire extinguisher valve 2, which comprises a manual lever 8 for operating the fire extinguisher valve 2 manually. This may allow for retrofitting a manually operable fire extinguisher valve 2 with a mechanical actuator 12, in order to provide an additional mechanical opening mechanism for the fire extinguisher valve 2, without having to replace the fire extinguisher valve 2. A fire extinguisher valve 2 according to an exemplary embodiment of the invention be still may operated manually. This set-up may provide a high operating safety, as the fire extinguisher valve 2 may still be activated without using the mechanical actuator 12.

Exemplary embodiments of the invention also include fire extinguishing systems, comprising at least one fire extinguisher valve 2 according to an embodiment of the invention.

FIG. 3 shows a fire extinguishing system 30 according to an exemplary embodiment of the invention. The fire extinguishing system 30, depicted in FIG. 3, is a portable handheld fire extinguishing system 30, which comprises a container or bottle, serving as a reservoir 32 for accommodating a fire extinguishing agent 35. A fire extinguisher valve 2 according to an exemplary embodiment of the invention is fluidly coupled to the reservoir 32 for controlling a flow of the fire extinguishing agent 35 out of the reservoir 32.

A lower part 33 of the reservoir 32 is depicted in a cut-open view, in order to show the fire extinguishing agent 35 within the reservoir 32.

In the embodiment depicted in FIG. 3, the input connector 4 of the fire extinguisher valve 2, which is shown in FIGS. 1A to 2C, is not visible, as it is arranged within the container.

The fire extinguishing agent 35, which is provided within the reservoir 32, may include at least one of a fire extinguishing gas, such as CO₂, a liquefied fire extinguishing gas, for example liquefied FE36, a fire extinguishing liquid, such as water, a dry chemical agent, in particular a dry chemical agent in powder form, and/or a foam agent, like DEUFOAM-Plus®. The fire extinguishing agent 35 may further include a propellant, such as nitrogen, for driving the liquid and/or the dry chemical agent out of the reservoir, when the fire extinguisher valve 2 is open.

The fire extinguishing system 30 further comprises a controller 34 for controlling the mechanical actuator 12. The controller 34 may in particular be configured for triggering the trigger mechanism 18, in order to cause the manual lever 8 to move from its closed position into its open position for opening the fire extinguisher valve 2, as it has been described before with reference to FIGS. 1A to 2C.

The controller 34 may comprises at least one fire alarm signal input 39 for receiving a fire alarm signal. The controller 34 may be configured for activating the mechanical actuator 12 upon receiving a fire alarm signal at the at least one fire alarm signal input 39. The fire alarm signal may, for example, by supplied by an external fire alarm switch (not shown), which is connected to the at least one fire alarm signal input 39.

The fire extinguishing system 30 may also comprise a wireless receiver 36, which is coupled to the controller 34 for communication with the controller 34. Providing a wireless receiver 36 allows for activating the fire extinguishing system 30 remotely by sending a wireless fire alarm signal to the receiver 36. The receiver 36 may by configured for receiving electromagnetic signals, in particular electromagnetic signals in the range of radio frequencies, more particularly frequencies in the range of between 20 kHz to 300 GHz, and/or infrared signals as fire alarm signals. It is also possible that the fire extinguishing system comprises a wired signal receiver.

Alternatively or additionally, the fire extinguishing system 30 may comprise at least one fire sensor 38 for detecting a fire in the vicinity of the fire extinguishing system 30. The at least one fire sensor 38 may include at least one temperature sensor 38a for detecting high temperatures in the vicinity of the fire extinguishing system 30 and/or at least one smoke sensor 38b for detecting smoke in the vicinity of the fire extinguishing system 30. Alternatively or additionally, the fire sensor functionality may be implemented via other types of fire sensors, such as a carbon monoxide sensor.

The at least one fire sensor 38 may be provided within the controller 34. The at least one fire sensor 38 may also be provided separately from the controller 34, and it may be configured for transmitting a fire alarm signal to the controller 34 via an electric connection or via wireless data transmission. This may allow for positioning the at least one fire sensor 38 in some distance from the controller 34, which may be beneficial for increasing the reliability of the at least one fire sensor 38 and/or for an early fire sensing at particularly sensitive locations.

Embodiments comprising at least one fire sensor 38 may allow for activating the fire extinguishing system 30 in an automated manner, i.e. activating the fire extinguishing system 30 without human intervention, in the case of fire.

With such an automated fire extinguishing system 30, fire may be fought fast and reliably, as there is no need for a human to notice the fire and to manually activate the fire extinguishing system 30.

The at least one fire sensor 38 may also include a combination comprising at least one a temperature sensor 38a and at least one a smoke sensor 38b and, potentially, other type(s) of fire sensors. In an embodiment comprising more than one fire sensor, the controller 34 may be configured for activating the mechanical actuator 12 when a fire has been detected by one of the fire sensors, in order to activate the fire extinguishing system 30 as fast as possible in the case of fire.

Alternatively, in order to reduce the risk of false alarms, the controller 34 may be configured for activating the mechanical actuator 12 only after a fire has been detected by at least two fire sensors.

A fire extinguishing system according to an exemplary embodiment of the invention may also be a stationary fire extinguishing system, which is installed within a building or a vehicle. Although a vehicle itself is mobile, a fire extinguishing system that is installed within a vehicle 50 is considered as a stationary fire extinguishing system, as it is stationary with respect to the vehicle.

FIG. 4 shows a building 40 that comprises a stationary fire extinguishing system 31 with a container, serving as a reservoir 32 for the fire extinguishing agent 35, as it has been described before, with a plurality of fire extinguisher valves 2, and with a plurality of fire extinguishing agent conduits 42, which fluidly connect the container with the fire extinguisher valves 2.

The plurality of fire extinguishing agent conduits 42 may be fluidly connected to the reservoir 32 for distributing the fire extinguishing agent 35 from the reservoir 32 into different parts of the building 40. One or more fire extinguisher valves 2 may be fluidly coupled to each of the fire extinguishing agent conduits 42 for selectively releasing the fire extinguishing agent 35 to different parts, in particular into different rooms 44, of the building 40.

Although a plurality of fire extinguisher valves 2 and a plurality of fire extinguishing agent conduits 42 are shown in FIG. 4, a stationary fire extinguishing system 31 according to an exemplary embodiment of the invention may also comprise only a single fire extinguishing agent conduit 42 and/or a single fire extinguisher valve 2.

A stationary fire extinguishing system 31, as it is depicted in FIG. 4, may comprise at least one controller 34, at least one receiver 36, and at least one fire sensor 38 for controlling the fire extinguisher valves 2 in an automated manner, as it has been described before for the fire extinguishing system 30, depicted in FIG. 3.

The stationary fire extinguishing system 31 may in particular comprise a plurality of fire sensors 38, which may be installed in different rooms 44 of the building 40, for a fast and reliable detection of a fire, which breaks out in one of the rooms 44.

The stationary fire extinguishing system 31, which comprises more than one fire extinguisher valve 2, may comprise a single controller 34, which is configured for controlling the operation of the mechanical actuators 12 of all fire extinguisher valves 2. Alternatively, the fire extinguishing system 30 may comprise a plurality of controllers 34, and each controller 34 may be configured for controlling the mechanical actuator 12 of one of the fire extinguisher valves 2 or the mechanical actuators 12 of a subgroup of the fire extinguisher valves 2.

For example, only the mechanical actuators 12 of the fire extinguisher valves 2 that are installed on a specific floor or within a specific room 44 or within a number of rooms 44 of the building 40 may be activated if a fire is detected on only one floor, in only one room 44 or in a number of rooms 44 of the building 40.

FIG. 5 shows a vehicle 50, in particular a car, with an engine 52, which is located within an engine compartment 54 of the vehicle 50.

A fire extinguishing system 31 according to an exemplary embodiment of the invention is provided within the engine compartment 54 of the vehicle 50.

Similar to the fire extinguishing systems depicted in FIGS. 3 and 4, the fire extinguishing system 31 of FIG. 5 comprises a reservoir 32 with a fire extinguishing agent 35 and a fire extinguisher valve 2, including a mechanical actuator 12, according to an exemplary embodiment of the invention. The mechanical actuator 12 is configured for opening the fire extinguisher valve 2 in case a fire is detected, in order to allow the fire extinguishing agent 35 to exit the reservoir 32 for extinguishing the fire.

The fire extinguishing system 31 further comprises a controller 34 for controlling the operation of the mechanical actuator 12 and at least one fire sensor 38 for detecting a fire, as it has been described before with reference to fire the extinguishing system 31 shown in FIG. 4.

The at least one fire sensor 38 may include at least one temperature sensor 38a for detecting alarmingly high temperatures in the vicinity of the fire extinguishing system 30 and/or at least one smoke sensor 38b for detecting smoke in the vicinity of the fire extinguishing system 30 and/or one or more other types of fire sensors.

The reservoir 32, the fire extinguisher valve 2, the controller 34, and the fire sensor 38 may be arranged next to each other, forming a compact fire extinguishing system 31, as it is depicted in FIG. 5.

In an alternative embodiment, the fire extinguisher valve 2 may be arranged at some distance from the reservoir 2, and it may be fluidly connected to the reservoir 32 by a fire extinguishing agent conduit (not shown in FIG. 5), similar to the embodiment depicted in FIG. 4.

Similarly, the controller 34 and/or the fire sensor 38 may be arranged at some distance from the fire extinguisher valve 2, and they may be coupled with each other and/or with the mechanical actuator 12 of the fire extinguisher valve 2 by electric connections, which are not explicitly shown in FIG. 5.

FIG. 6 shows another vehicle 50, in particular a bus, with an engine 52, which is located within an engine compartment 54 of the vehicle 50. The vehicle 50 further comprises a cockpit 60, a passenger cabin 56 and a baggage compartment 58, which is provided below the passenger cabin 56.

For extinguishing fires, which may break out in the baggage compartment 58, a fire extinguishing system 31 according to an exemplary embodiment of the invention is provided within the baggage compartment 58.

The fire extinguishing system 31 comprises a reservoir 32, including a fire extinguishing agent 35, a fire extinguisher valve 2 with a mechanical actuator 12 according to an exemplary embodiment of the invention, and a controller 34 for controlling the operation of the mechanical actuator 12.

A plurality of fire sensors 38 are provided within the baggage compartment 58 for detecting fires. The fire sensors 38 may include at least one temperature sensor 38a for detecting alarmingly high temperatures in the vicinity of the fire extinguishing system 30 and/or at least one smoke sensor 38b for detecting smoke in the vicinity of the fire extinguishing system 30 and/or one or more other types of fire sensors.

The fire sensors 38 may be coupled with the controller 34 by wires (not shown) or by wireless connections, in order to allow the fire sensors 38 to transmit fire alarm signals to the controller 34 in case a fire has been detected. Although a plurality of fire sensors 38 are depicted in FIG. 6, the fire extinguishing system 31 according to an exemplary embodiment of the invention may also comprise only a single fire sensor 38.

The fire extinguishing system 31 further comprises a fire extinguishing agent conduit 42, which extends through the baggage compartment 58. A plurality of fire extinguishing agent openings or nozzles 46 are provided at the fire extinguishing agent conduit 42 for distributing the fire extinguishing agent 35 within the baggage compartment 58, in case a fire has been detected and the fire extinguisher valve 2 has been opened.

Although a plurality of fire extinguishing agent openings or nozzles 46 are depicted in FIG. 6, a fire extinguishing system 31 according to an exemplary embodiment of the invention may also comprise only a single fire extinguishing agent opening or nozzle 46. A fire extinguishing system 31 according to an exemplary embodiment of the invention may also comprise more than one fire extinguishing agent conduit 42.

The fire extinguishing system 31 may further comprise at least one fire alarm switch 48, which may be provided in the cockpit 60 of the vehicle 50, in order to allow a driver of the vehicle 50 to manually activate the fire extinguishing system 31 by manually operating the fire alarm switch 48.

Although not explicitly depicted in FIG. 6, a fire extinguishing system 31 according to an exemplary embodiment of the invention may also be installed within the engine compartment 54 and/or within the passenger cabin 56 of the vehicle 50.

The vehicle 50 may also be equipped with a fire extinguishing system 31 that includes fire extinguishing agent openings or nozzles 46 in at least two of the engine compartments 54, the passenger cabin 56 and the baggage compartment 58 of the vehicle 50, in order to allow fighting fires in any of these compartments 54, 56, 58 with a single fire extinguishing system 31.

While the invention has been described with reference to an exemplary embodiment, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention is not limited to the particular embodiment disclosed, but that the invention will include all embodiments falling within the scope of the appended claims.

1. Fire extinguisher valve for controlling a flow of a fire extinguishing agent in a fire extinguishing system, the fire extinguisher valve comprising:
a valve body;
a manual lever, which is manually movable between an open position, in which a fire extinguishing agent discharge path through the valve body is established, and a closed position, in which the fire extinguishing agent discharge path through the valve body is closed; and
a mechanical actuator, which is mounted to and supported by the valve body, and which comprises:
an actuation element for acting upon the manual lever for moving the manual lever from its closed position to its open position;
an elastic element for moving the actuation element, and
a trigger mechanism for holding the actuation element in a preloaded position, in which the elastic element is preloaded, and for releasing the actuation element, when the mechanical actuator is activated.

2. Fire extinguisher valve according to claim 1, wherein the elastic element comprises a spring.

3. Fire extinguisher valve according to claim 1, wherein the spring is a compression spring.

4. Fire extinguisher valve according to claim 1, wherein the elastic element is configured for causing the actuation element to exert a force in a range of between 50 N and 250 N.

5. Fire extinguisher valve according to claim 4, wherein the elastic element is configured for causing the actuation element to exert a force in a range of between 90 N and 150 N, onto the manual lever.

6. Fire extinguisher valve according to claim 1, wherein the trigger mechanism comprises a latch.

7. Fire extinguisher valve according to claim 1, wherein the trigger mechanism is an electromagnetic trigger mechanism.

8. Fire extinguisher valve of claim 7, wherein the electromagnetic trigger mechanism comprises a solenoid.

9. Fire extinguisher valve according to claim 1, wherein the mechanical actuator is a separate component, which is mountable and individually separable from the valve body.

10. Fire extinguisher valve according to claim 9, wherein the mechanical actuator is configured to be retrofitted to an existing fire extinguisher valve.

11. Fire extinguishing system, comprising:
a reservoir for accommodating a fire extinguishing agent; and
a fire extinguisher valve according to claim 1;
wherein the fire extinguisher valve is fluidly coupled to the reservoir for controlling a flow of the fire extinguishing agent out of the reservoir.

12. Fire extinguishing system according to claim 11, further comprising a fire extinguishing agent within the reservoir, wherein the fire extinguishing agent includes at least one of a gas, a liquefied gas, a liquid, and/or a dry chemical agent.

13. Fire extinguishing system according to claim 12, wherein the dry chemical agent includes a dry chemical agent in powder form.

14. Fire extinguishing system according to claim 11, wherein the fire extinguishing system further comprises:
at least one of a fire sensor for detecting a fire and a fire alarm signal input for receiving a fire alarm signal; and
a controller for activating the mechanical actuator when a fire has been detected and/or when a fire alarm signal has been received.

15. Fire extinguishing system according to claim 11, wherein the fire extinguishing system is a portable fire extinguishing system and/or wherein the fire extinguishing system is a handheld fire extinguishing system.

16. Fire extinguishing system according to claim 11, wherein the fire extinguishing system is a stationary fire extinguishing system, wherein the fire extinguishing system is configured to be installed in a building or in a vehicle.

17. Vehicle comprising a fire extinguishing system according to claim 11, wherein the vehicle includes a land vehicle.

18. Vehicle according to claim 17,
wherein the vehicle comprises an engine in an engine compartment, and wherein the fire extinguishing system is at least partially located within the engine compartment; and/or
wherein the vehicle (50) comprises a passenger cabin (56) and the fire extinguishing system (31) is at least partially located within the passenger cabin (56); and/or
wherein the vehicle (50) comprises a baggage compartment (58) and the fire extinguishing system (31) is at least partially located within the baggage compartment (58).

19. Method of operating a fire extinguisher valve according to claim 1, wherein the method includes:
activating the mechanical actuator;
as a response to activating the mechanical actuator, releasing the actuation element; and
with the actuation element, moving the manual lever from its closed position to its open position.

20. Method of retrofitting a fire extinguisher valve for controlling a flow of a fire extinguishing agent in a fire extinguishing system, the fire extinguisher valve comprising a valve body and a manual lever, which is manually movable between an open position, in which a fire extinguishing discharge path through the valve body is established, and a closed position, in which the fire extinguishing discharge path through the valve body is closed, wherein the method includes:
mounting a mechanical actuator to the valve body of the fire extinguisher valve, wherein the mechanical actuator comprises an elastic element, which acts upon an actuation element for moving the manual lever from its closed position to its open position, and a trigger mechanism for holding the actuation element in a preloaded position and for releasing the actuation element, when the mechanical actuator is activated.
